(19) United States
(12) Patent Application Publication
(10) Pub. No.: US 2025/0085677 A1
(43) Pub. Date: Mar. 13, 2025

(54) Method for controlling the operation of a machine, operation control device for a machine and system with a machine having an operation control device

(71) Applicant: Hoffmann + Krippner GmbH, Buchen (DE)

(72) Inventors: Ralf Krippner, Buchen (DE); Jens Schnur, Oberzent (Olfen) (DE)

(73) Assignee: Hoffmann + Krippner GmbH, Buchen (DE)

(21) Appl. No.: 18/829,870

(22) Filed: Sep. 10, 2024

(30) Foreign Application Priority Data
Sep. 12, 2023 (DE) 10 2023 124 635.6

(51) Int. Cl. G05B 15/02

(52) U.S. Cl. CPC G05B 15/02

(57) ABSTRACT

A method for controlling the operation of a machine includes an identification step in which a unique operating controller address is acquired by a portable data processor. In a loading request step a data-transmitting connection of the potable data transmitter to a control server is established, and a loading request containing the operating controller address is transmitted to the control server. In a loading checking step the control server checks the loading request and generates an item of use cycle enablement information. In a loading confirmation step an item of use cycle enablement information is transmitted from the control server to the operating controller. In a control step a check is made by the operating controller as to whether the use cycle enablement information fulfils the enablement requirement of the activation of the machine requested by the activation request.

### CROSS-REFERENCE TO RELATED APPLICATION

This application claims the benefit of German Patent Application DE 10 2023 124 635.6, filed on Sep. 12, 2023, the content of which is incorporated in its entirety.

### BACKGROUND

Completely different machines are known from many different fields of use, by means of which machines in each case a single firmly predetermined machine program or a machine program selected individually from a number of a plurality of different machine programs can be performed in numerous use cycles. Thus, for example, coffee machines can offer different coffee beverages and perform these in succession, depending on the respective activation requirements. In the case of a washing machine, the washing program suitable for the respective washing can be selected from different washing programs and can be performed for cleaning laundry. As an example for a machine that is used industrially, a machine tool can be cited, by means of which numerous use cycles for repeated production of a machined product can be carried out. By means of a 3D printer, a number of similar or different objects can be produced in succession by means of a generative manufacturing method.

All these machines are also suitable for use of said machines in return for payment, such that independently of a respective user, the activation of a use cycle of the machine takes place only if the payment of a usage fee has been agreed in advance and possibly also already paid.

For example in the case of automatic washing machines, which are set up in launderettes or in buildings with a plurality of residential units, it is known that such an automatic washing machine comprises an operating controller configured as a coin-operated machine. Depending on the respective configuration, a coin-operated machine can perform activation of the automatic washing machine or enable the activation of a washing program selected via a control element of the automatic washing machine, after receiving a predetermined number of coins or a coin amount. In this case, it is considered disadvantageous, during use, that each individual use of the automatic washing machine requires a suitable coin amount to be paid into the coin-operated machine. Furthermore, the coins collected in a coin container, in the coin-operated machine, must be emptied at intervals, which incurs additional running costs for the operation of such an automatic washing machine.

Machines are also known in which, instead of coins, for example an enablement code has to be input manually into the operating controller, or can be transmitted to the operating controller using a portable data processor, for example a smartphone, in order to enable a single use cycle or a number of use cycles, which can subsequently be enabled by the operating controller in response to corresponding activation requests and be performed by the machine. Such operating controller are routinely integrated into a machine controller, which results in significant construction effort. A machine must then already be equipped with the corresponding operating controller upon production of the machine, and cannot readily be used retrospectively without said operating controller. On account of often very significant production effort for two different versions of a machine, which are equipped either without or with an operating controller, only a few machines are equipped with such an operating controller. The outlay for use of a machine comprising such an operating controller is very significant in particular for frequently changing users or in the case of a frequent change in the use of such machines, and therefore the use of the machines with operating controller is considered not to be particularly convenient.

### SUMMARY

The disclosure relates to a method for controlling the operation of a machine using a machine controller by which a plurality of use cycles of a machine program can be performed. After receiving an activation request, in a control step before activation of a use cycle, a check is made by an operating controller as to whether an enablement requirement for performing a machine program is fulfilled. In an enablement step, an activation of a use cycle requested by the activation request is enabled, such that the machine can perform the machine program, when the enablement requirement is fulfilled and, in the enablement step, the requested activation is not enabled if the enablement requirement is not fulfilled. The disclosure also relates to an operating controller for a machine comprising a machine controller, by which a plurality of use cycles of a machine program can be performed. The operating controller comprises a data transmitter for wireless transmission of data to a portable data processor. The disclosure furthermore also relates to a system comprising a machine having an operating controller and comprising a portable data processor. The operating controller and the portable data processor are configured such that data from the operating controller can be transmitted to the portable data processor, and comprising a control server which can be wirelessly connected, for data transmission, both to the operating controller and also to the portable data processor.

An object of the disclosure is that of configuring a method for controlling the operation of a machine with an operating controller, and a corresponding operating controller, in such a way that a use of the machine in return for payment can be performed as easily and as conveniently as possible.

This object is achieved by a method having the method steps mentioned at the outset, in which, in an identification step, a unique operating controller address is acquired by a portable data processor. In a loading request step a data-transmitting connection of the potable data transmitter to a control server is established, and a loading request containing the operating controller address is transmitted to the control server. In a loading checking step the control server checks the loading request and generates an item of use cycle enablement information. In a loading confirmation step, a data-transmitting connection between the control server and the operating controller identified via the operating controller address is established, and an item of use cycle enablement information is transmitted from the control server to the operating controller. In the control step, a check is made by a processor of the operating controller as to whether the use cycle enablement information fulfils the enablement requirement of the activation of the machine requested by the activation request.

An advantage of the disclosure is considered to be the fact that a user merely has to acquire, using the portable data processor, or example using a smartphone, in the identification step, an unique operating controller address and transmit it, together with the loading request, to the control server, while the use cycle enablement information is transmitted from the control server to the operating controller without further interaction by the use, and as a result the machine is enabled and can be used for at least one further use cycle.

The loading checking step is performed with the control server, such that for example in each case a loading checking step for different machines and also for different users can be performed using the same control server. In the case of the relevant machine, no loading checking step has to be performed, which facilitates the handling and operation of the machine for the user. Thus, the control server can comprise a uniformly configured operator interface for a plurality of different machines, such that the user can perform a uniform activation process for entirely different machines, which can significantly improve the user acceptance for the machines controlled thereby.

A payment process for use of a machine in return for payment can be performed entirely via the control server. There, a user account can also be kept for an individual user, and a previously paid use fee can be managed, such that in the case of a loading request triggered by a user, irrespective of the machine in question in each case, the user information stored and managed in the user account can be called up, and the payment process can be performed in a convenient manner.

The operating controller of the respective machine merely has to be able to check the use cycle enablement information transmitted by the control means, and to be able to initiate or refuse the desired activation of the machine, depending on the use cycle enablement information. The structural complexity, required for this, for the operating controller is comparatively low. The operating controller possibly does not even have to be able to check one of the different enablement requirements of the activation of the machine requested by the activation request, but rather merely to check whether the use cycle enablement information allows the activation of the machine requested by the activation request, or allows the activation of the machine, requested by the user, independently of a specific use cycle requested by the activation request.

In order to simplify the transmission, triggered by a user, of a specific loading request to the control server, and to configure this so as to be as simple and failsafe as possible for the user, it can be provided for the operating controller to comprise an identification memory having a unique operation control means addressed stored there, and for the operating controller addressed to be transmitted automatically to the portable data processor, in the identification step, as soon as a distance between the portable data processor and the operating controller is smaller than a specifiable minimum distance. In this way, the operating controller address, which uniquely identifies the respective machine, is automatically transmitted to the portable data processor of a user, as soon as the user comes sufficiently close to the relevant machine. An unintended incorrect entry by the user, which cannot be assigned to the machine in question, can be excluded in this way.

If the user runs a suitable software application on their portable data processor, with the aid of the software application a user interface can be offered via the operating controller address, which was automatically transmitted to the portable data processor, with which interface the user can select the relevant machine with a single keystroke or a single input, and request the activation of a use cycle. Optionally, different use cycles which can be performed by said machine can be offered to the user for selection. In this way, the operation and activation of the machine can be significantly simplified for the user, and furthermore be configured to be particularly reliable and failsafe.

According to an embodiment, it can be provided for the operating controller to comprise a control server contact memory having control server contact data stored there, and for the control server contact data to be transmitted automatically to the portable data processor, in the identification step. In this way, data transmission from the portable data processor to the control server can be configured such that it can be reliable and failsafe, and easy for the user to perform, without a separate software application which would have to be previously installed and run on the portable data processor. Thus, for example the control server contact data and the operating controller address can be transmitted from the portable data processor to the control server, identifiable via the control server contact data, with the aid of standardised data transmission protocols. In parallel therewith, a browser can be activated on the portable data processor, which browser exchanges data with the control server identified via the control server contact data, and with the aid of which information relating to the relevant machine, which is associated with the operating controller address, and use cycles that can be performed by said machine, are displayed on the portable data processor, without the need for extensive interaction and input of data by the user. It may also be provided that the control server contact data are automatically made available to the user, but the user thereof and for example the transmission of a loading request to the control server can be made dependent on an interaction and enablement by the user.

In order to reduce the risk of improper use of the machine or of a user account, linked to the respective user, in the control server, it can optionally be provided for the data-transmitting connection between the control server and the operating controller to be performed encrypted, in the loading confirmation step. The encryption of the data transmission between the control server and the operating controller can be predetermined and also performed by hardware-side encryption means in the operating controller and in the control server. In this way, it is possible to prevent an unauthorised user transmitting an item of use cycle enablement information for example from a portable data processor to the operating controller, which is not generated by the control server and transmitted to the operating controller. It is also possible to prevent an unauthorised user from improperly using user information of an authorised user and generating an item of use cycle enablement information and thus transmitting an item of use cycle enablement information to the operating controller, in order to cause the activation of a use cycle of the relevant machine.

According to a particularly advantageous embodiment it can be provided for the operating controller to comprise a use cycle number information memory for storing use cycle number information, for an item of use cycle number information to be stored or adjusted in the use cycle number information memory, in the loading confirmation step, proceeding from the use cycle number enablement information transmitted to the use operating controller, and for the use cycle number information to be reduced, in the enablement step, after completed enablement of an activation of a use cycle requested by the activation request, by a use cycle number corresponding to the completed activation. With the aid of the use cycle number information memory, for example not only a one-time activation of a use cycle can be requested and made possible with a single loading request, but rather a repeated use of the machine can be enabled. I this way, a user can enable a repeated activation or a repeated performance of individual use cycles with a single loading request and a single corresponding payment process.

By means of the storage of the use cycle number information in the use cycle number information memory, for example after a successfully performed loading confirmation step, a use cycle number or an item of use cycle number information, which represents a number of use cycles enabled in the loading confirmation step, can be reduced and adjusted, and the machine can be available for further use cycles, as long as the use cycle number or the corresponding use cycle number information still allows further use cycles.

The operating controller can comprise a display device for displaying the use cycle number or the use cycle number information, and a separate activation actuation means, by which a further use cycle can be activated if the stored use cycle number or the use cycle number information still allows a further activation of the use cycle requested by the activation actuation means. In this way, the use of the machine can also be made possible and performed if no data transmission to a portable data processor is possible, because the data transmitter is for example located outside of the range of the operating controller or is not in a data-transmitting state. Likewise, no data-transmitting connection between the control server and the operating controller is required, as long as the use cycle number stored in the operating controller, or the use cycle number information, still allows one or more further use cycles.

It can optionally be provided, in view of greater operating comfort, for the activation request to be transmitted from the portable data processor to the control server, and from the control server to the operating controller. A user can not only transmit a loading request to the control server, using the portable data processor, but rather simultaneously generate a specific activation request for the relevant machine and transmit this to the control server. The activation request contains information relating to the machine program selected by the user to be performed. If various machine programs can be performed by the machine, a user must merely transmit the relevant activation request to the control server, using the data transmitter. Since the control server also transmits the activation request to the operating controller, after checking the enablement requirement the machine program requested in the activation request can be started by the operating controller, immediately and without further intervention by the user. A separate selection or activation actuation by the user, by actuating an activation actuation means of the operating controller, is then not required.

The disclosure also relates to an operating controller for a machine comprising a machine controller, by means of which a plurality of use cycles of a machine program can be performed, wherein the operating controller comprises a data transmitter for wireless transmission of data to a portable data processor, characterised in that the operating controller comprises a data transmitter for wireless transmission of data with a control server, in that the operating controller comprises a processor for processing data which are transmitted from the control server to the operating controller, in that the operating controller comprises an interface for connection to the machine controller of the machine, and in that the operating controller comprises an enablement switch which is connected to the processor and by means of which a machine program, performable using the machine control means, can be enabled or activated via the interface. An operating controller of this kind can be produced and provided as a separate component, and can, without great effort, be integrated into the machine and be connected via the interface to the machine controller of the machine. In this way, virtually any machine can be equipped with such an operating controller without significant structural effort, without intervention in the machine controller or in further machine components being required. In a structurally particularly simple implementation, the interface can for example comprise a switching means, which can be arranged on an electrical supply line of the machine in such a way that the electrical supply of the machine can be interrupted or enabled, by the switching means, depending on the enablement switch.

The data transmitter of the operating controller must be suitable and configured for performing a data transmission with the control server, and in the process being able to receive data from the control server. In many cases, standardised data transmission modules and data transmission protocols can be used in the process, as are known and used on the Internet or in the transmission of mobile communications data. The data transmitter should be designed and configured in such a way that a data transmission to a spatially remote control server is also possible.

In order that a user can transmit a loading request to the control server, for a desired use of the machine, using a portable data processor, the user must identify the machine in question. This can take place in that the user manually acquires an operating controller address and inputs it into the portable data processor. An automatic acquisition of the operating controller address can also be made possible, for example in that a machine-readable code, for example a QR code or a barcode, to be applied to the operating controller, which can be read in using the portable data processor.

According to an advantageous embodiment, it is optionally provided for the operating controller to comprise an identification memory having a unique operating controller address stored there. The operating controller address can be requested and read out automatically from the operating controller, via a portable data processor, or can be transmitted from the operating controller to the portable data processor. It is also conceivable for the operating controller to be configured such that, in the case of the portable data processor approaching the operating controller, the operating controller address can be transmitted automatically to the portable data processor, using suitable near-field data transmission modules and data transmission protocols, such as Bluetooth or NFC, such that the operating controller address can be transmitted from the operating controller to the portable data processor without any intervention by the user.

Preferably it is optionally provided for the identification memory to comprise a memory region that cannot be written with data during a use period. In this way, it is possible to exclude the possibility that an operating controller address stored in the non-overwritable memory region of the identification memory being abusively or inadvertently overwritten or deleted during a subsequent use of the operating controller, with a machine. This significantly reduces the risk of abusive manipulation or unintentional impairment of the operating controller, and the machine program activatable thereby.

The operating controller can be operated in such a way that the operating controller can exclusively receive and evaluate use cycle enablement information, from a control server, which is transmitted from an optionally firmly specified or from any, and previously or subsequently authorised, control server to the operating controller. In order to reduce the risk of abusive use of the operating controller, it can be provided for the operating controller to either in principle not send out any data, or to not send out any data other than the operating controller address.

It can optionally be provided, according to an advantageous embodiment, for the operating controller to comprise a control server contact memory having control server contact data stored there. The control server contact data stored there can selectively be sent out and transmitted to the portable data processor only upon request, or automatically and optionally together with the operating controller address. By means of a suitable software application, the control server contact data can be used or partially or fully automatic data transmission between the portable data processor and the control server, and for example using a suitable browser or a separate software data can be called up from the control server and displayed on a suitably designed portable data processor, on a user interface predetermined by the control server or linked with information. It is then not necessary for a user to themselves identify and contact a suitable control server, with which an item of use cycle enablement information can be transmitted from the relevant control server to the operating controller. It can also be provided for the operating controller to check whether an item of use cycle enablement information is transmitted from a control server to the operating controller, the operating controller address of which corresponds to the control sever contact data stored in the control server contact memory of the operating controller. Optionally, control server contact data of a plurality of different control server can also be stored in the control server contact memory, in order to be able to compensate for a possible failure of a control server or a temporarily prevented data transmission with one individual control server by changing to another control server.

In order to allow for data transmission between the control server and the operating controller that is encrypted, and thereby protected against unauthorised manipulation, it can optionally be provided for the processor to be configured for decrypting encrypted data which are transmitted from the control server to the operating controller.

It can be provided for the operating controller to be configured such that the use cycle enablement information transmitted from the control server to the operating controller is checked by the processor only in the control step, and in the process it is determined whether the use cycle enablement information fulfils the enablement requirement of the activation of the machine requested by the activation request, in order to enable the requested activation or to prevent an activation of a machine program, depending on the outcome of the check. In this case, an associated transmission of use cycle enablement information from the control server to the operating controller is required for each individual activation of a machine program.

It can optionally also be provided and advantageous for the operating controller to comprise a use cycle enablement information memory for storing use cycle enablement information. In this case, the use enablement information can for example contain information relating to a number of use cycles which can be enabled following one-time transmission of use cycle enablement information, without renewed data transmission from the control server to the operating controller being required. The use enablement information can also contain information relating to a quantity of a machine program duration or a consumable material required for performing a machine program, which information is transmitted from the control server to the operating controller and stored in the use cycle enablement information memory, in order to be able to be called up for subsequent activation requests and to be able to be adjusted after an activated machine program has been performed.

It may be the case that a plurality of machines, and in particular a plurality of machines of the same type, is in each case equipped with an operating controller which each comprise a use cycle number information memory. A user can, with a suitable loading request, cause an item of use cycle number information to be transmitted from the control server to an operating controller previously identified by said user, with which information the activation of a plurality of use cycles is possible. For example, the machine could be a washing machine usable by different people, which is equipped with a suitable operating controller. A user can, by way of the above-described method, cause an item of use cycle number information to be transmitted to the operating controller, which information corresponds for example to five or ten washing processes, which can then be activated and performed on the relevant washing machine without renewed data exchange with a control server.

It is also possible that for example in a launderette a plurality of washing machines may be available, which can be used by the user simultaneously or in succession for performing a washing process. If each of said washing machines is equipped with a suitable operating controller, the user can activate a washing process for each washing machine they have selected, using only their smartphone or another suitable portable data processor.

According to a particularly advantageous embodiment, it is optionally provided that, after a loading request step, in a control server use cycle information request step, the control server, in the case of a plurality of other operating controller, calls up the use cycle number information stored there in a use cycle number information memory, and determines whether an item of use cycle number information matching the loading request is stored in one of the called-up other operating controller, and that, in the loading confirmation step, not only is a data-transmitting connection between the control server and the operating controller identified by the operating controller address established and an item of use cycle enablement information transmitted from the control server to the operating controller, but rather in addition, in the called-up other operating controller, the use cycle number information stored in the use cycle number information memory thereof is changed and stored again, depending on the use cycle enablement information transmitted to the operating controller identified via the operating controller address, in the loading confirmation step. In this way, it is possible for the control server, after receiving a loading request for an operating controller, to first request, with other operating controller which can also be contacted via the control server, whether an item of use cycle number information suitable for the current loading request is possible already stored in their use cycle number information memory. For example comparable use cycles or value equivalents, which can be associated with the use cycle number information in question, can be criteria for suitable use cycle number information. Furthermore, a reference to the same user, which must be able to be established via the use cycle number information, can serve as a criterion.

If the control server can determine an item of use cycle number information by a request to another operation control means, which information matches the loading request triggered by the user, instead of an otherwise necessary new payment process, the use cycle number information already transmitted to another operating controller can be used in order to be able to activate the machine program desired by the user, using the operating controller currently identified by said user. In this case, subsequently a use cycle number information on the other operating controller must also be changed correspondingly. In this way, a user in a launderette can load a washing machine, selected by them, with an item of use cycle number information, via a loading request, which information corresponds to a plurality of washing processes. If said user subsequently wishes to also activate and perform a washing process on other washing machines in the launderette, at the same tine or in succession, it is possible to request, via a control server use cycle information request step, whether corresponding credit or matching use cycle number information is stored on an operating controller of one of the available washing machines, in order to subsequently use this credit or the relevant use cycle number information in order to also perform washing processes on other washing machines.

In a comparable manner, it can optionally also be provided that, in a local loading request step, the operating controller identified via the operation control means address, in the case of a plurality of other operating controller, calls up the use cycle number information stored there in a use cycle number information memory and determines whether an item of use cycle number information matching the loading request is stored in one of the called-up other operating controller, and that, in a local loading confirmation step, an item of use cycle enablement information is transmitted from the requested other operating controller to the operating controller, and that in addition, in the requested other operating controller, the use cycle number information stored in its use cycle number information memory is amended and stored again depending on the use cycle enablement information transmitted to the operating controller identified via the operating controller address in the local loading confirmation step. The individual operating controller of the plurality of machines can, in this way, correspond to one another and make it possible for a user to activate a machine program on a machine they have selected, as long as sufficient credit or a matching item of use cycle number information is stored on another machine. By way of the activation of the machine program on the selected machine, the use cycle number information on the other operation control means, the use cycle number information of which was called up and used for the activation, is then adjusted accordingly.

The local loading request step and the local loading confirmation step can be performed without a data-transmitting connection to the control server. It is furthermore possible for the operating controller to in each case comprise dedicated data transmitter for data exchange with other operating controller, which data transmitter can be operated independently of a data transmission with the control server. It can also be provided and advantageous for these dedicated data transmitter are configured for other data transmission methods and use other data transmission protocols.

According to an optional embodiment, it can be provided for the operating controller to comprise a display. The display can for example comprise one or more light indicators, which can light up in one colour or with different colours, and can display a current status of the operating controller and in particular an enabled or refused activation request. The display can also for example comprise a liquid crystal display or a small monitor, on which detailed information about the respective state and possible operating options for the operating controller can be displayed.

Furthermore, it can optionally be provided, in an advantageous manner, for the operating controller to comprise at least one actuatable operating element, by means of which an activation request can be generated. A user can then generate an activation request by actuation of the operating element, in order to activate a predetermined machine program of the machine controlled by the operating controller. This activation request can be transmitted, together with a unique operating controller address, from a portable data processor, automatically or by interaction with a user, to a control server, in order to subsequently be transmitted, together with an item of use cycle enablement information, from the control server to the operating controller, such that the machine program desired by the activation request can be activated and performed without further interaction or actuation by the user. In this way, the operation of the machine with the operating controller can be facilitated and configured to be even more convenient for the user.

If, in addition, the information required for a loading request step is stored in the user's portable data processor and can be called up and transmitted to the control server automatically following receipt of an activation request, the enablement and activation of a machine program can be brought about exclusively by a corresponding actuation of an operating element of the operating controller, without the user having to interact with the portable data processor or having to perform additional actuation steps with the portable data processor.

In an advantageous manner, it is provided for the operating controller to be configured for performing the method according to any of the variants explained above. In this case, it is considered to be a significant advantage that the operating controller can be produced separately from the machine and optionally by a different manufacturer, and merely has to be connected to the machine via the interface. The machine comprise its own machine control program that functions autonomously, independently of the operating controller, and can also be used without a connection to the operating controller. The machine can be easily equipped retrospectively with the operating controller, and in this way configured such that an enablement by a control server, which is previously essentially required, takes place for performing a machine program.

Irrespective of the specific embodiment of the operating controller, the operating controller can comprise a closed operating controller housing, which can be easily mechanically connected to a machine and comprises a suitably configured interface. The operating controller can also be configured such that the operating controller can be connected to the machine, instead of a machine operating means, or can be configured such that the operating controller, after being arranged and fixed on a machine housing, covers the machine operating means and renders this inaccessible or no longer operable for a user. It can also be provided that the connection of the operating controller to the machine deactivates a machine operating means, and the machine can be activated and actuated only via the operating controller.

A further advantage is that, in the case of the relevant machine, its machine control program and also its machine housing, do not have to be configured or adjusted separately for enablement by a control server, such that the same machine can be actuated and used either without an operating controller or with an operating controller, optionally retrospectively installed thereon.

The disclosure also relates to a system comprising a machine having an operating controller and having a portable data processor, and having a control server which can be wirelessly connected, for data transmission, both to the operating controller and to the portable data processor. It is provided that the operating controller is an operating controller having the, sometimes optional, features set out above, and that the operating controller, the portable data processor and the control server are configured for performing the method described above for controlling the operation of the machine. It can optionally be provided that the operating controller and the portable data processor are configured such that data can be transmitted from the operating controller to the portable data processor.

In the following, various embodiments of the inventive concept are explained in greater detail, which embodiments are shown by way of example and schematically in the drawings.

### BRIEF DESCRIPTION OF THE DRAWINGS

FIG. 1 is a schematic view of a system comprising a machine having an operating controller and having a portable data processor, as well as a schematic course of the method for operating and controlling the machine,

FIG. 2 is a schematic view of a machine comprising a machine control program and comprising an operating controller which is connected to the machine via an interface,

FIG. 3 is a schematic view of a machine comprising a machine control program and comprising an operating controller, deviating from the embodiment shown in FIG. 2, connected to the machine via an interface,

FIG. 4 is a schematic view of an operating controller, with the aid of which it is possible to perform a method for controlling the operation of a machine,

FIG. 5 is a schematic view of a control server use cycle information request step, with the aid of which the use cycle number information of a plurality of other operating controller is called up by a control server, and

FIG. 6 is a schematic view of a local loading request step, with the aid of which the use cycle number information of a plurality of operating controller is called up by an operating controller.

### DETAILED DESCRIPTION

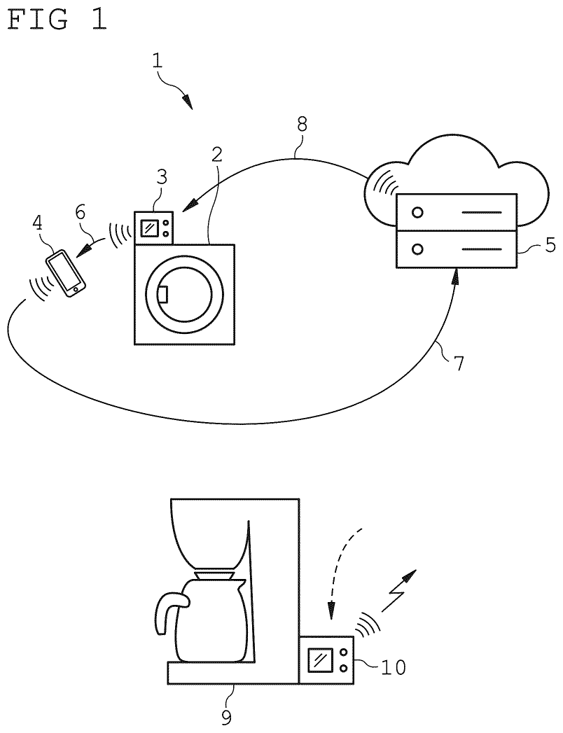

The system 1 shown by way of example in FIG. 1 comprises a machine 2 by means of which two or more different machine programs can be performed. The machine 2 can for example be a washing machine, by means of which two or more different washing programs can be performed. The individual machine programs are controlled by a machine controller (not shown in further detail in FIG. 1). A user (likewise not shown) can selectively activate the machine program, such that the selected machine program, after activation thereof, can be performed automatically with the aid of the machine controller.

An operating controller 3 is connected to the machine 2 via an interface (not shown in greater detail). The operating controller 3 may have been integrated into the machine 2 by the manufacturer during production of the machine 2, and connected to the machine 2 via the interface, or may have been produced separately by the manufacturer of the machine 2 or by another manufacturer, and retrospectively fixed to the machine 2 or integrated therein and have been connected to the machine 2 via the interface.

If a user wishes to activate a machine program of the machine 2, the user must transmit a loading request for the relevant machine 2 to a control server 5, using a portable data processor 4, for example a suitably configured mobile device. In order to identify the relevant machine 2, the user must, in an identification step 6, acquire a unique operating controller address by means of the portable data processor 4. This ca take place for example in that the user brings the portable data processor 4 into the vicinity of the operating controller 3, such that the operating controller address can be transmitted from the operating controller 3 to the portable data processor, using a suitable data transmission protocol. Expediently, the operating controller 3 and the portable data processor 4 are configured such that the transmission of the operating controller address can be performed only with in a spatial distance of a few centimetres, decimeters, or metres. In this case, the operating controller 3 can also continuously transmit the operating controller address, and the portable data processor 4 can automatically receive the operating controller address, as soon as the portable data processor 4 is brought closer to the operating controller 3 than said predetermined spatial distance. The user can also input the operating controller address manually or scan it in and acquire it automatically, for example via a barcode or QR code.

Subsequently, the user can select one of the plurality of machine programs which can be performed by means of the relevant machine 2. With the aid of the portable data processor 4, the user then transmits a loading request, containing the operating controller address, to the control server 5, in a loading request step 7. In this case, any desired data transmission method or any desired data transmission protocol can be used. Advantageously, a data transmission method suitable over large spatial distances is used. It is also possible for a plurality of data transmission methods to be used for different portions of the data transmission.

Together with or after the transmission of the loading request, a payment process is performed, by means of which the user pays a usage fee that is predetermined for performance of the machine program using the machine 2. An effective and sufficient payment by the user is checked using the control server 5, in a loading checking step.

In a subsequent loading confirmation step 8, the control server 5 establishes a data-transmitting connection between the control server 5 and the operating controller 3 identified via the operating controller address, and transmits an item of use cycle enablement information from the control server 5 to the operating controller 3.

In a control step, a processor of the operating controller 3 checks whether the use cycle enablement information fulfils the enablement requirement of the activation of the machine 2 that is requested by way of the activation request. The activation request may have been input to the machine 2 by the user via an actuation element of the operating controller 3. The activation request may also have been predetermined via an interaction of the user with the portable data processor 4 and may have been transmitted via the control server 5, together with the use cycle enablement information, to the operating controller 3. In the control step, a check is made as to whether an enablement requirement for the performance of the machine program selected by the activation request is fulfilled. Then, in an enablement step, either the activation of a use cycle requested by the activation request is enabled, such that the machine can perform the machine program, if the enablement requirement is fulfilled, or the requested activation is not enabled, if the enablement requirement is not fulfilled. Following completed enablement, the selected machine program can then be activated and performed.

FIG. 1 shows yet a further machine 9, merely by way of example, which is also connected to an operating controller 10. Said operating controller 10 has another operating controller address, via which the respective machines 2, 9 are in each case uniquely identified and can be activated by means of the method described above for performing a respective machine program.

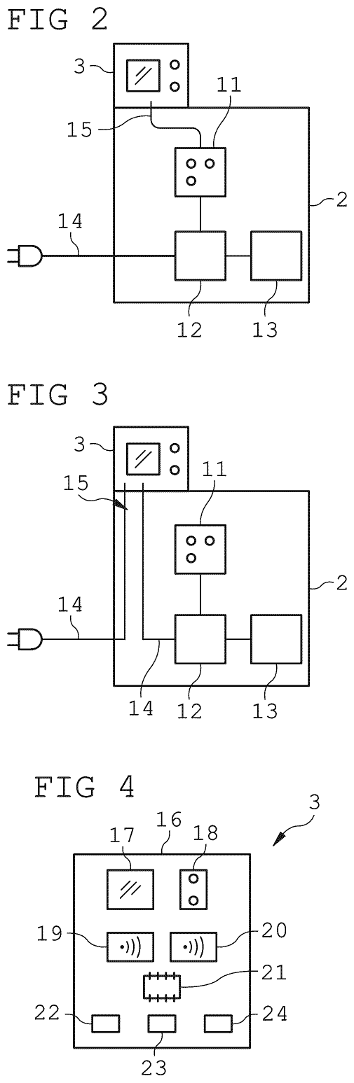

FIG. 2 is a schematic view, by way of example, of an embodiment for a machine 2 which is connected to the operating means 3. The machine 2 comprises a machine operating means 11 and a machine controller 12 that is connected thereto. A machine program means 13 for performing a machine program can be activated, controlled and monitored using the machine controller 12. The machine controller 12 is connected via an electrical supply line 14 to an electrical supply unit (not shown) or to an electrical supply network.

The operating controller 3 is connected via an interface 15 either via the machine operating means 11 or directly to the machine controller 12. A machine program requested by an activation request can be enabled or activated by the operating controller 3, via the interface 15, using an enablement switch (not shown in greater detail). Without enablement of the requested machine program by the operating controller 3, the requested machine program cannot be activated and performed.

It is also possible, and shown by way of example in FIG. 3, that the interface 15 is designed and configured such that the enablement switch can interrupt or enable an energy supply via the electrical supply line 14, using the interface 15, as a result of which activation and performance of a machine program selected by a user either via the operating controller 3 or via the machine operating means 11 is enabled or prevented.

FIG. 4 shows an embodiment, by way of example, of an operating controller 3. The operating controller 3 comprises an operating controller housing 16. A display 17, visible from the outside, and a plurality of operating elements 18, actuatable from the outside, are arranged on the operating controller housing 16. A first data transmission module 19 for automated sending of an operating controller address, and a second data transmission module 20 for receiving an item of use cycle enablement information from the control server 5 are arranged on or in the operating controller housing 16. Furthermore, a processor 21 is arranged in the operating controller housing 16, by means of which processor the use cycle enablement information transmitted from the control server 5 can be evaluated, and the control step for enabling or refusing the performance of a machine program can be performed. The operating controller 3 can optionally comprise a control server contact memory 22 having control server contact data stored there, a use cycle number information memory 23 for storing use cycle number information, and/or an identification memory 24 having a unique operating controller address stored there.

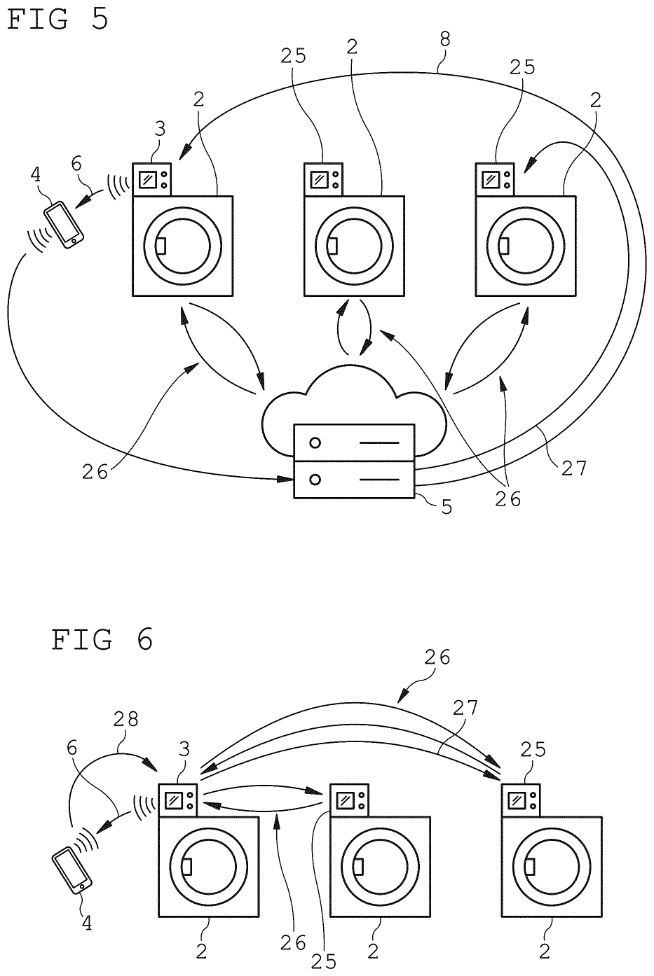

FIG. 5 schematically shows a control server use cycle information request step, on the basis of an example of a launderette comprising a plurality of machines 2 configured in each case as a washing machine and each comprising an operating controller 3. After receiving a loading request for a machine 2 selected by the user in the loading request step 7, the control server 5 of the machine 2 and of all other machines 2 with another operating controller 25 calls up, in a use cycle number information request step 26, an item of use cycle number information stored there in the relevant use cycle number information memory 23. Subsequently, the control server 5 checks whether an item of use cycle number information is stored in the operating controller 3 of the machine 2 selected by the user or in one of the other operating controller 25 of the other machines 2, in the associated operating controller 3, which information matches the loading request and would allow the machine program desired by the user to be performed on the machine 2 selected by said user. If a suitable item of use cycle number information is determined in the use cycle number information request step 26, then the control server 5 transmits an item of use cycle enablement information to the machine 2, selected by the user in the loading confirmation step 8. Furthermore, in a use cycle number information adjustment step 27, the control server 5 transmits a correspondingly amended item of use cycle number information to the other operating controller 25 of which the use cycle number information was called up and used for the loading confirmation step 8, which amended item of information is reduced, compared to previously, by one use cycle enablement, in order that this amended item of use cycle number information an be stored in the other operating controller 25 of the other machine 2.

FIG. 6 schematically shows the course of a local loading request step, by means of which the use cycle number information of a plurality of different operating controller 25 is called up by an operating controller 3. The operating controller 3 of a machine 2 selected by the user receives an activation request 28 from the user's portable data processor 4. If the use cycle number information stored in the operating controller 3 does not allow for enablement of the machine program specified in the activation request 28, then the operating controller 3 calls up, from other operating controller 25 of other machines 2, in a use cycle number information request step 26, an item of use cycle number information in each case, stored there in the relevant use cycle number information memory 23. A data-transmitting connection to the control server 5 is not necessary in this case. If a suitable item of use cycle number information is determined in the use cycle number information request step 26, then the operating controller 3 enables, in an enablement step, an activation of a use cycle requested by the activation request. Furthermore, the operating controller 3 transmits, in a use cycle number information adjustment step 27, a correspondingly amended item of use cycle number information to the other operating controller 25, the use cycle number information of which was called up and used for the enablement and activation of the machine 2, which amended information is reduced by one use cycle enablement, compared with previously, in order that said amended use cycle number information can be stored in the other operating controller 25 of the other machine 2.

By means of the two courses of methods shown schematically in FIGS. 5 and 6, it is possible for example, in a launderette having a plurality of washing machines, in a one-time loading process, via the control server 5, to load a selected washing machine with credit allowing a plurality of washing processes or to store a corresponding item of use cycle number information n the relevant operating controller 3, in order to be able to subsequently perform a plurality of washing processes using this use cycle number information, also on other washing machines, without a user having to again perform a payment process and a corresponding loading process via the control server 5.

What is claimed is:

1. A method for controlling operation of a machine (2, 9) using a machine controller (12), by which a plurality of use cycles of a machine program can be performed, comprising:
checking, after receiving an activation request, in a control step before activation of a use cycle, by an operating controller (3, 10) whether an enablement requirement for performing the machine program is fulfilled;
enabling, in an enablement step, an activation of the use cycle requested by the activation request, such that the machine (2, 9) can perform the machine program, if the enablement requirement is fulfilled and not enabling, in the enablement step, the requested activation if the enablement requirement is not fulfilled;
acquiring, in an identification step (6), a unique operating controller address by a portable data processor (4);
establishing, in a loading request step (7), a data-transmitting connection of the portable data processor (4) to a control server (5), and transmitting a loading request containing the operating controller address to the control server (5);
checking, in a loading checking step, by the control server (5) the loading request and generating an item of use cycle enablement information;
establishing, in a loading confirmation step (8), a data-transmitting connection between the control server (5) and the operating controller (3, 10) identified via the operating controller address, and transmitting the item of use cycle enablement information from the control server (5) to the operating controller (3, 10); and
checking, in the control step, by a processor (21) of the operating controller as to whether the use cycle enablement information fulfils the enablement requirement of the activation of the machine (2, 9) requested by the activation request.

2. The method according to claim 1,
wherein the operating controller (3, 10) comprises an identification memory (24) having a unique operating controller address stored there, and
wherein, in the identification step (6), the operating controller address is automatically transmitted to the portable data processor (4), as soon as a distance between the portable data processor (4) and the operating controller (3, 10) is smaller than a predeterminable minimum distance.

3. The method according to claim 1,
wherein the operating controller (3) comprises a control server contact memory (22) having control server contact data stored there, and
wherein, in the identification step (6), the control server contact data are transmitted automatically to the portable data processor (4).

4. The method according to claim 1,
wherein, in the loading confirmation step (8), the data-transmitting connection between the control server (5) and the operating controller (3, 10) is performed in an encrypted manner.

5. The method according to claim 1,
wherein the operating controller (3, 10) comprises a use cycle number information memory (23) for storing use cycle number information,
wherein, in the loading confirmation step (8), proceeding from the use cycle enablement information transmitted to the operating controller (3, 10), the item of use cycle number information is stored or adjusted in the use cycle number information memory (23), and
wherein, in the enablement step, after completed enablement of an activation of a use cycle requested by the activation request, an item of use cycle number information is reduced by a use cycle number that corresponds to a completed activation.

6. The method according to claim 5,
wherein, after the loading request step (7), in a control server use cycle information request step, the control server calls up the use cycle number information stored in the use cycle number information memory (23) of a plurality of other operating controllers (25), and determines whether an item of use cycle number information matching the loading request is stored in one of the other operating controllers (25), and
wherein, in the loading confirmation step (8), not only is the data-transmitting connection established between the control server (5) and the operating controller (3, 10) identified by the operating controller address and an item of use cycle enablement information transmitted from the control server (5) to the operating controller (3, 10), but rather in addition, in the other operating controllers (25), the use cycle number information stored in the use cycle number information memory (23) thereof is amended and stored again, depending on the use cycle enablement information transmitted in the loading confirmation step (8) to the operating controller (3, 10) identified via the operating controller address.

7. The method according to claim 5,
wherein, in a local loading request step (7), in an operating means use cycle information request step, the operating controller (3, 10) identified via the operating controller address calls up the use cycle number information stored there in the use cycle number information memory (23) of a plurality of other operating controllers (25) and determines whether an item of use cycle number information matching the loading request is stored in one of the other operating controllers (25), and
wherein, in the loading confirmation step (8), not only is the data-transmitting connection established between the control server (5) and the operating controller (3, 10) identified via the operating controller address and an item of use cycle enablement information transmitted from the control server (5) to the operating controller (3, 10), but rather, in addition, in the other operating controllers (25), the use cycle number information stored in the use cycle number information memory (23) thereof is amended and stored again, depending on the use cycle enablement information transmitted in the loading confirmation step (8) to the operating controller (3, 10) identified via the operating controller address.

8. The method according to claim 1,
wherein the activation request is transmitted from the portable data processor (4) to the control server (5), and from the control server (5) to the operating controller (3, 10).

9. An operating controller (3, 10) for a machine (2, 9) comprising a machine controller (12) by which a plurality of use cycles of a machine program can be performed,
wherein the operating controller (3, 10) comprises:
a data transmitter (19) for wireless transmission of data to a portable data processor (4);
a data transmitter (20) for wirelessly receiving data with a control server (5);
a processor (21) for processing data which are transmitted from the control server (5) to the operating controller (3, 10);
an interface (15) for connection to the machine controller (12) of the machine; and
an enablement switch which is connected to the processor (21) and by which the machine program that can be performed by the machine controller (12) can be enabled or activated via the interface (15).

10. The operating controller (3, 10) according to claim 9,
wherein the operating controller (3, 10) comprises an identification memory (24) having a unique operating controller address stored there.

11. The operating controller (3, 10) according to claim 10,
wherein the identification memory (24) comprises a storage region that cannot be written with data during a usage period.

12. The operating controller (3, 10) according to claim 9,
wherein the operating controller (3, 10) comprises a control server contact memory (22) having control server contact data stored there.

13. The operating controller (3, 10) according to claim 9,
wherein the processor (21) is configured for decrypting encrypted data which are transmitted from the control server (5) to the operating controller (3, 10).

14. The operating controller (3, 10) according to claim 9,
wherein the operating controller (3, 10) comprises a use cycle enablement information memory (23) for storing use cycle enablement information.

15. The operating controller (3, 10) according to claim 9,
wherein the operating controller (3, 10) comprises a display (17).

16. The operating controller (3, 10) according to claim 9,
wherein the operating controller (3, 10) comprise at least one actuatable operating element (18), by which an activation request can be generated.

17. An operating controller (3, 10) configured to perform the method according to claim 1.

18. A system, comprising:
a machine comprising the operating controller (3, 10) according to claim 9;
a portable data processor (4); and
a control server (5) which can be wirelessly connected, for data transmission, both to the operating controller (3, 10) and to the portable data processor (4).

19. The system according to claim 18
wherein the operating controller (3, 10) and the portable data processor (4) are configured such that data can be transmitted form the operating controller (3, 10) to the portable data processor (4).

20. A system, comprising an operating controller (3, 10), a portable data processor (4), and a control server (5), the system being configured for performing the method for controlling operation of the machine according to claim 1.
